(19) United States
(12) Patent Application Publication
(10) Pub. No.: US 2024/0075938 A1
(43) Pub. Date: Mar. 7, 2024

(54) Device and Method for Exact Seat Occupancy Identification

(71) Applicant: Bayerische Motoren Werke Aktiengesellschaft, Muenchen (DE)

(72) Inventor: Marjan BUZANIN, Muenchen (DE)

(21) Appl. No.: 18/229,716

(22) Filed: Aug. 3, 2023

(30) Foreign Application Priority Data
Sep. 5, 2022 (DE) 10 2022 122 348.5

(51) Int. Cl. B60W 40/08; B60N 2/00

(52) U.S. Cl. CPC B60W 40/08; B60N 2/0024; B60W 2540/043; B60W 2540/221

(57) ABSTRACT

The present invention comprises a device and a method for exact seat occupancy identification in a vehicle. The device comprises an ultra-wideband (UWB) radar comprising a transmitter (TRx) and at least two receivers (TRx, Rx). The transmitter (TRx) is configured to emit a plurality of preamble symbols in the direction of a vehicle seat of the vehicle. The at least two receivers (TRx, Rx) are configured to receive the preamble symbols reflected by the vehicle seats. A computer is configured to generate Channel Impulse Responses (CIRs) from the received, reflected preamble symbols and process the generated CIRs with the aid of a suitable machine learning algorithm. The computer is further configured to perform an angle-of-arrival calculation based on the reflected preamble symbols and determine an occupancy of the vehicle seats from the processed CIRs and the performed angle-of-arrival calculation.

### CROSS REFERENCE TO RELATED APPLICATION

This application claims priority under 35 U.S.C. § 119 from German Patent Application No. 102022122348.5, filed Sep. 5, 2022, the entire disclosure of which is herein expressly incorporated by reference.

### BACKGROUND AND SUMMARY

The present subject matter relates to a device and a method for exact seat occupancy identification.

Seat occupancy sensors may be used to identify seat occupancy. Seat occupancy sensors comprise a plurality of switching elements, for example pressure sensors, which is arranged distributed in the seat surface of the vehicle seat. The seat occupancy sensor is connected to an evaluation unit, which acquires the switching state of the plurality of switching elements and determines an occupancy status of the seat from the acquired switching states. If a person occupies a vehicle seat, the weight force exerted by the person on the seat triggers multiple switching elements, due to which the occupancy status of the seat is identified by the evaluation unit. This has the disadvantage that an occupancy status is incorrectly identified by the evaluation unit also due to weight force exerted on the seat by objects or animals. In addition, a costly seat occupancy sensor has to be kept in stock for each vehicle seat. Moreover, seat occupancy sensors are restricted in a resolution of the age classification of persons occupying the seat in the case of children.

The object of the present subject matter is to provide a solution which enables exact seat occupancy identification.

The above-mentioned object is achieved by a device for exact seat occupancy identification in the vehicle, comprising:

an ultra-wideband (UWB) radar comprising a transmitter and at least two receivers,
wherein the transmitter TRx is configured to emit a plurality of preamble symbols in the direction of vehicle seats of a vehicle;
wherein the at least two receivers TRx, Rx are configured to receive the preamble symbols reflected by the vehicle seats; and

a computer, which is configured:
to generate channel impulse responses (CIRs) from the received reflected preamble symbols and to process the generated CIRs with the aid of a suitable machine learning algorithm;
to perform an angle-of-arrival calculation based on the reflected preamble symbols; and
to determine an occupancy of the vehicle seats from the processed CIRs and the performed angle-of-arrival calculation.

In the context of the document, the term vehicle comprises mobile means of transportation which are used to transport persons (passenger traffic), goods (freight transport), or tools (machines or implements). In particular, the term vehicle comprises motor vehicles and also motor vehicles which can be at least partially electrically driven (electric car, hybrid vehicles).

The vehicle can be controlled by a vehicle driver. Additionally or alternatively, the vehicle can be a vehicle driving in an at least partially automated manner. The tem “vehicle driving in an automated manner” or “automated driving” can be understood in the scope of the document as driving having automated longitudinal or lateral control or autonomous driving having automated longitudinal and lateral control. Automated driving can involve, for example, driving over a longer time on the freeway or driving for a limited time in the context of parking or maneuvering. The term “automated driving” comprises automated driving with an arbitrary degree of automation. Exemplary degrees of automation are assisted, partially automated, highly automated, or fully automated driving. These degrees of automation were defined by the Bundesanstalt für Straßenwesen [German Federal Highway Research Institute] (BASt) (see BASt publication “Forschung kompakt [compact research]”, edition November 2012). In assisted driving, the driver continuously executes the longitudinal or lateral control, while the system takes over the respective other function in certain limits. In partially automated driving, the system takes over the longitudinal and lateral control for a certain period of time and/or in specific situations, wherein the driver has to continuously monitor the system as in assisted driving. In highly automated driving, the system takes over the longitudinal and lateral control for a certain period of time without the driver having to continuously monitor the system; however, the driver has to be capable of taking over the vehicle control in a certain time. In fully automated driving, the system can automatically manage the driving in all situations for a specific application; a driver is no longer necessary for this application. The above-mentioned four degrees of automation correspond to the SAE levels 1 to 4 of the norm SAE J3016 (SAE—Society of Automotive Engineering). Furthermore, SAE level 5 is also provided as the highest degree of automation in SAE J3016, which is not included in the definition of the BASt. SAE level 5 corresponds to driverless driving, in which the system can automatically manage all situations like a human driver during the entire journey.

The device comprises an ultra-wideband (UWB) radar. The frequency range of the UWB radar can be variable between 6.5 GHz and 8.0 GHz, the bandwidth can be 500 MHz. The UWB radar can be a UWB anchor and comprises a transmitter or a transmitter antenna Tx, TRx and at least two receivers or receiver antennas TRx, Rx, wherein Tx=transmitter antenna, TRx=transmitter and receiver antenna, Rx=receiver antenna.

By means of the transmitter TRx or Tx, the UWB radar generates a plurality of repeating preamble symbols via the synchronization header of a radar frame according to the IEEE-UWB radio communication protocol IEEE 6.8 Mbps frame according to IEEE 802.15.4z-2020. The UWB radar is configured to transmit a plurality of repeating preamble symbols in the direction of vehicle seats via a transmitter or a transmitter antenna TRx or Tx. For this purpose, for example, a UWB radar can be attached in each case on the roof lining in the middle above a bench seat or a row of seats in the vehicle. The vehicle seats reflect this plurality of preamble symbols. The UWB radar is configured to receive the preamble symbols reflected by the vehicle seat by means of at least two receivers or receiver antennas TRx or Rx.

The device comprises a computer. The computer is configured to generate channel impulse responses (CIRs) from the reflected preamble symbols. The generation of the CIRs can be carried out by means of phase matching according to the above-mentioned IEEE-UWB radio communication protocol. The computer is configured to process the generated CIRs with the aid of or using suitable machine learning algorithms.

The computer is configured to perform an angle-of-arrival calculation based on the reflected preamble symbols. The angle-of-arrival calculation results from the use of the following formula for angle calculation in the frequency or time domain:

$$θ = arcsin ( ψ \frac{c}{2 π fd} ) ( frequency domain ) = arcsin ( \frac{c}{d} Δ t ) ( time domain ) ,$$

wherein

θ=angle of the identified object or subject on the vehicle seat in relation to the UWB radar;

c=speed of light;

d=distance between the receiver antennas TRx, Rx;

ƒ=frequency of the communication channel used, defined according to IEEE 802.15.4z-2020;

Δt =time difference with respect to the incidence or the reflected preamble symbols at the at least two receivers TRx or Rx;

ψ=phase difference, wherein the phase difference is a time difference with respect to the incidence or the reflected preamble symbols at the at least two receivers TRx or Rx.

The angle-of-arrival calculation results in the angle of the identified object or subject with respect to the UWB radar, by which the exact position of the identified object or subject in the vehicle or the vehicle seat occupied by the identified object or subject in the vehicle can be determined.

By processing the CIRs and performing the angle-of-arrival calculation, the computer can advantageously determine exactly for each vehicle seat whether it is occupied and whether the occupancy is performed by a person, an animal, or an object.

In addition, the exact seat occupancy identification takes place in a cost-effective manner, since UWB anchors are installed in any case in the vehicle upon the provision of digital vehicle keys or digital keys, as defined by the Standard Car Connectivity Consortium®. It is therefore not necessary to provide a separate sensor system required for this purpose for the seat occupancy identification.

The computer is preferably moreover configured, upon the processing of the CIR process, to perform a classification of a person determined upon the determination of the occupancy of the vehicle seats with respect to
an age of the person; and/or
a health status of the person.

Using suitable machine learning algorithms—for detecting an object or subject on a vehicle seat—upon identification of a person in the vehicle, a classification of this person with respect to an age of the person and/or a health status of the person can also be performed. The processing of the CIRs also enables the generation of a volume model of the identified person. Different aspects can be derived therefrom, such as a height of the person, a respiration or a breathing rate of the person, head movements of the person, etc. From these aspects, it is possible by means of the machine learning algorithms to exactly determine an age group of the person (e.g., child, adult, senior, animal, etc.) and a health status (for example, correlation of determined age group to breathing rate).

A classification of an identified person with respect to age, health status, etc. is thus advantageously enabled in addition.

The device preferably moreover comprises an electronic control unit, which is configured to control or regulate one or more vehicle functions based on the determined occupancy of the vehicle seats;

wherein the one or more vehicle functions can comprise:
a safety belt warning system of the vehicle seat; and/or
a controller of the airbag assigned to the vehicle seat; and/or
an airbag warning system assigned to the vehicle seat; and/or
a ventilation and/or climate control system assigned to the vehicle seat; and/or
a seat heater assigned to the vehicle seat; and/or
an entertainment system assigned to the vehicle seat; and/or
a child safety lock assigned to the vehicle seat of the corresponding vehicle door and/or the corresponding vehicle window; and/or
any further system assigned to the vehicle seat.

The device comprises an electronic control unit which is configured to control or regulate one or more vehicle functions based on the determined occupancy of the vehicle seats.

The vehicle functions can comprise a safety belt warning system of a vehicle seat. If it is identified, for example, that a vehicle seat is not occupied or is occupied by an object and/or an animal, the electronic control unit can control the safety belt warning system in such a way that it does not output a warning for the corresponding vehicle seat. In contrast, if it is identified that a vehicle seat is occupied by a person, the electronic control unit can control the safety belt warning system in such a way that a warning is output for the corresponding vehicle seat when the safety belt is not applied.

The vehicle functions can comprise a controller of the airbag assigned to the vehicle seat. For example, if it is identified that a vehicle seat is not occupied or is occupied by an object and/or an animal, the electronic control unit can control the controller of the airbag assigned to the vehicle seat in such a way that in case of an event triggering the airbag the airbag is not triggered. In contrast, if it is identified that a vehicle seat is occupied by a person, the electronic control unit can control the controller of the airbag assigned to the vehicle seat in such a way that in case of an event triggering the airbag the airbag is triggered. If it is established, for example, that a vehicle seat is occupied by a child seat oriented backward in the travel direction having a child lying or seated therein, the electronic control unit can control the controller of the airbag assigned to the vehicle seat in such a way that it is deactivated.

A precise control of safety-critical or safety-relevant vehicle functions with respect to the vehicle seat is advantageously enabled by the exact determination of the occupancy of the vehicle seats or the exact seat occupancy identification—with respect to an age classification of a person occupying a vehicle seat.

The vehicle functions can comprise a ventilation and/or climate control system assigned to the vehicle seat. The electronic control unit can control or regulate the ventilation and/or climate control system assigned to the vehicle seat based on the exact seat occupancy identification.

The vehicle functions can comprise a seat heater assigned to the vehicle seat. The electronic control unit can control or regulate the seat heater assigned to the vehicle seat based on the exact seat occupancy identification.

The vehicle functions can comprise an entertainment system assigned to the vehicle seat. The electronic control unit can control or regulate the entertainment system assigned to the vehicle seat based on the exact seat occupancy identification.

The vehicle functions can comprise a child safety lock of the corresponding vehicle door and/or the corresponding vehicle window assigned to a vehicle seat. The electronic control unit can control or regulate the child safety lock of the corresponding vehicle door and/or the corresponding vehicle window assigned to the vehicle seat based on the exact seat occupancy identification.

The vehicle functions can comprise any further system assigned to a vehicle seat, which can be controlled or regulated by the electronic control unit based on the exact seat occupancy identification.

According to a second aspect, the underlying object is achieved by a vehicle comprising a device according to any one of claims 1-3.

According to a third aspect, the underlying object is achieved by a method for exact seat occupancy identification in the vehicle, comprising:

transmitting, via a transmitter (TRx) of a UWB radar, a plurality of preamble symbols in the direction of vehicle seats of a vehicle;

receiving, via at least two receivers (TRx, Rx) of the UWB radar, the preamble symbols reflected by the vehicle seat;

generating, via a computer, Channel Impulse Responses (CIRs) from the reflected preamble symbols;

processing, via a computer, the CIRs by means of a suitable machine learning algorithm;

performing, by the computer, an angle-of-arrival calculation based on the reflected preamble symbols; and

determining, via the computer, an occupancy of the vehicle seats from the processed CIRs and the performed angle-of-arrival calculation.

The computer is preferably moreover configured, in the processing of the CIRs, to perform a classification of a person determined in the determination of the occupancy of the vehicle seats with respect to
an age of the person; and/or
a health status of the person.

The method preferably moreover comprises:

controlling or regulating, via an electronic control unit, one or more vehicle functions based on the determined seat occupancy of the vehicle seat.

The one or more vehicle functions preferably comprise:
a safety belt warning system of the vehicle seat; and/or
a controller of the airbag assigned to the vehicle seat; and/or
an airbag warning system assigned to the vehicle seat; and/or
a ventilation and/or climate control system assigned to the vehicle seat; and/or
a seat heater assigned to the vehicle seat; and/or
an entertainment system assigned to the vehicle seat; and/or
a child safety lock assigned to the vehicle seat of the corresponding vehicle door and/or the corresponding vehicle window; and/or
any further system assigned to the vehicle seat.

According to a fourth aspect, the underlying object is achieved by a computer program having program code which is configured, when it is executed on a computer, to carry out the method according to any one of claims 5 to 7.

According to a fifth aspect, the underlying object is achieved by a computer-readable data carrier having program code of a computer program which is configured, when it is executed on a computer, to catty out the method according to any one of claims 5 to 7.

These and other objects, features, and advantages of the present subject matter will become clear from studying the following detailed description of preferred examples and the appended figures. It is apparent that—although examples are described separately—individual features therefrom can be combined to form additional examples.

Other objects, advantages and novel features of the present subject matter will become apparent from the following detailed description of one or more preferred examples when considered in conjunction with the accompanying drawings.

### BRIEF DESCRIPTION OF THE DRAWINGS

FIG. 1 schematically shows a device for exact seat occupancy identification in the vehicle;

FIG. 2 shows an example method for exact seat occupancy identification in the vehicle.

### DETAILED DESCRIPTION

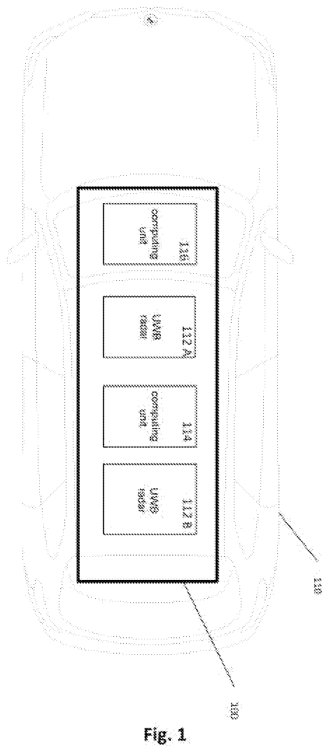

FIG. 1 schematically shows a device 100 for exact seat occupancy identification in the vehicle 110.

The device comprises at least one ultra-wideband (UWB) radar 112 A, 112 B comprising a transmitter or a transmitter antenna Tx, TRx and at least two receivers or receiving antennas TRx, Rx, wherein Tx=transmitter antenna, TRx=transmitter and receiver antenna, Rx=receiver antenna.

By means of the transmitter TRx or Tx, the UWB radar 112 A, 112 B generates a plurality of repeating preamble symbols of the synchronization header with a radar frame according to the IEEE-UWB radio communication protocol IEEE 802.15.4a.

The UWB radar 112 A, 112 B is configured to transmit, via a transmitter or a transmitter antenna TRx or Tx, a plurality of repeating preamble symbols in the direction of vehicle seats. For this purpose, for example, UWB radar 112 A, 112 B can be attached in each case on the roof lining in the middle above a bench seat or a row of seats in the vehicle 110. The vehicle seats reflect this plurality of preamble symbols. The UWB radar 112 A, 112 B is configured, by means of at least two receivers or receiving antennas TRx or Rx, to receive the preamble symbols reflected by the vehicle seat.

The device 100 comprises a computer 114. The computer 114 is configured to generate Channel Impulse Responses (CIRs) from the reflected preamble symbols. The generation of the CIRs can be carried out by means of phase matching according to the IEEE-UWB radio communication protocol. The computer 114 is configured to process the generated CIRs with the aid of or using suitable machine learning algorithms. The processing of the CIRs results in the determination of an occupancy of the vehicle seats.

The computer 114 is configured to perform an angle-of-arrival calculation based on the reflected preamble symbols. The angle-of-arrival calculation results from the use of the following formula for angle calculation in the frequency or time domain:

$$θ = arcsin ( ψ \frac{c}{2 π fd} ) ( frequency domain ) = arcsin ( \frac{c}{d} Δ t ) ( time domain ) ,$$

wherein

θ=angle of the identified object or subject on the vehicle seat in relation to the UWB radar;

c=speed of light;

d=distance between the receiver antennas TRx, Rx;

ƒ=frequency of the communication channel used, defined according to IEEE;

Δt=time difference with respect to the incidence or the reflected preamble symbols at the at least two receivers TRx or Rx;

ψ=phase difference, wherein the phase difference is a time difference with respect to the incidence or the reflected preamble symbols at the at least two receivers TRx or Rx.

The angle-of-arrival calculation results in the angle of the identified object or subject with respect to the UWB radar 112 A, 112 B, by which the exact position of the identified object or subject in the vehicle 110 or the vehicle seat, which is occupied by the identified object or subject, can be determined.

The computer 114 can exactly determine by the processing of the CIRs and the performance of the angle-of-arrival calculation for each vehicle seat whether it is occupied and whether the occupancy is carried out by a person, an animal, or an object.

The computer 114 can moreover be configured, upon the processing of the CIR process, to perform a classification of a person determined upon the determination of the occupancy of the vehicle seats with respect to
an age of the person; and/or
a health status of the person.

Using suitable machine learning algorithms—for detecting an object or subject on a vehicle seat—upon identification of a person in the vehicle, a classification of this person with respect to an age of the person and/or a health status of the person can also be performed. In particular, the processing of the CIRs also enables the generation of a volume model of the identified person. Different aspects can be derived therefrom, such as a height of the person, a respiration or a breathing rate of the person, head movements of the person, etc. From these aspects, it is possible by means of the machine learning algorithms to exactly determine an age group of the person (e.g., child, adult, senior, etc.) and a health status (for example, correlation of determined age group to breathing rate).

A classification of an identified person with respect to age, health status, etc. is thus advantageously enabled in addition.

The device 100 can comprise an electronic control unit 116, which is configured to control or regulate one or more vehicle functions based on the determined occupancy of the vehicle seats.

The vehicle functions can comprise a safety belt warning system of a vehicle seat. If it is identified, for example, that a vehicle seat is not occupied or is occupied by an object and/or an animal, the electronic control unit can control the safety belt warning system in such a way that it does not output a warning for the corresponding vehicle seat. In contrast, if it is identified that a vehicle seat is occupied by a person, the electronic control unit 116 can control the safety belt warning system in such a way that a warning is output for the corresponding vehicle seat when the safety belt is not applied.

The vehicle functions can comprise a controller of the airbag assigned to the vehicle seat. For example, if it is identified that a vehicle seat is not occupied or is occupied by an object and/or an animal, the electronic control unit 116 can control the controller of the airbag assigned to the vehicle seat in such a way that in case of an event triggering the airbag the airbag is not triggered. In contrast, if it is identified that a vehicle seat is occupied by a person, the electronic control unit 116 can control the controller of the airbag assigned to the vehicle seat in such a way that in case of an event triggering the airbag the airbag is triggered. If it is established, for example, that a vehicle seat is occupied by a child seat oriented backward in the travel direction having a child lying or seated therein, the electronic control unit 116 can control the controller of the airbag assigned to the vehicle seat in such a way that it is deactivated.

A precise control of safety-critical or safety-relevant vehicle functions with respect to the vehicle seat is advantageously enabled by the exact determination of the occupancy of the vehicle seats or the exact seat occupancy identification—with respect to an age classification of a person occupying a vehicle seat.

The vehicle functions can comprise a ventilation and/or climate control system assigned to the vehicle seat. The electronic control unit 116 can control or regulate the ventilation and/or climate control system assigned to the vehicle seat based on the exact seat occupancy identification.

The vehicle functions can comprise a seat heater assigned to the vehicle seat. The electronic control unit 116 can control or regulate the seat heater assigned to the vehicle seat based on the exact seat occupancy identification.

The vehicle functions can comprise an entertainment system assigned to the vehicle seat. The electronic control unit 116 can control or regulate the entertainment system assigned to the vehicle seat based on the exact seat occupancy identification.

The vehicle functions can comprise a child safety lock of the corresponding vehicle door and/or the corresponding vehicle window assigned to a vehicle seat. The electronic control unit 116 can control or regulate the child safety lock of the corresponding vehicle door and/or the corresponding vehicle window assigned to the vehicle seat based on the exact seat occupancy identification.

The vehicle functions can comprise any further system assigned to a vehicle seat, which can be controlled or regulated by the electronic control unit 116 based on the exact seat occupancy identification.

The control or regulation of seat-related vehicle functions, but in particular also a control or regulation of safety-critical vehicle functions (for example airbag control) with respect to a vehicle seat is advantageously enabled in a safe manner by the exact seat occupancy identification.

The term module (and other similar teal's such as unit, subunit, submodule, etc.) in the present disclosure may refer to a software module, a hardware module, or a combination thereof. Modules implemented by software are stored in memory or non-transitory computer-readable medium. The software modules, which include computer instructions or computer code, stored in the memory or medium can run on a processor or circuitry (e.g., ASIC PLA, DSP, FPGA, or other integrated circuit) capable of executing computer instructions or computer code. A hardware module may be implemented using one or more processors or circuitry. A processor or circuitry can be used to implement one or more hardware modules. Each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices and stored in memory or non-transitory computer readable medium.

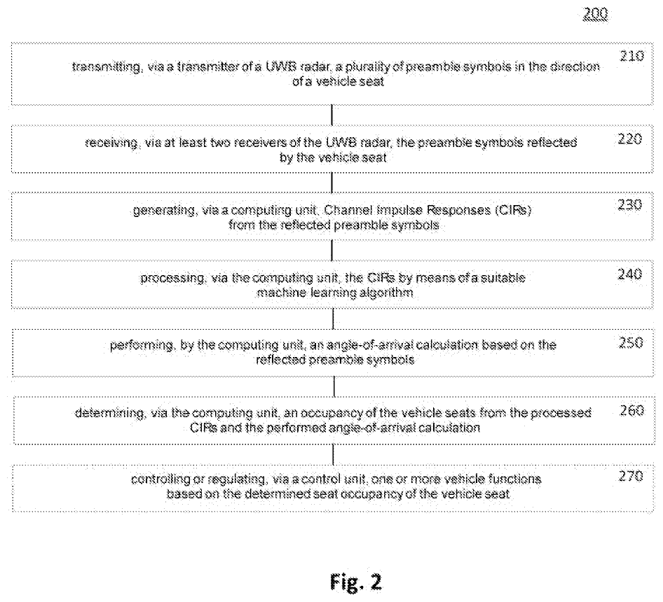

FIG. 2 shows a method 200 for exact seat occupancy identification in the vehicle 110, which can be carried out by a device 100 as described with reference to FIG. 1.

The method 200 comprises:

transmitting 210, via a transmitter TRx of a UWB radar 112, a plurality of preamble symbols in the direction of vehicle seat of a vehicle;

receiving 220, via at least two receivers TRx, Rx of the UWB radar, the preamble symbols reflected by the vehicle seats;

generating 230, via a computer 114, Channel Impulse Responses (CIRs) from the reflected preamble symbols;

processing 240, via the computer 114, the CIRs by means of a suitable machine learning algorithm;

performing 250, by the computer 114, an angle-of-arrival calculation based on the reflected preamble symbols; and

determining 260, via the computer 114, an occupancy of the vehicle seats from the processed CIRs and the performed angle-of-arrival calculation.

The computer 114 can moreover be configured, in the processing of the CIRs, to perform a classification of a person determined in the determination of the occupancy of the vehicle seats with respect to

an age of the person; and/or

a health status of the person.

The method can moreover comprise:

controlling or regulating 270, via an electronic control unit 116, one or more vehicle functions based on the determined seat occupancy of the vehicle seat.

The one or more vehicle functions preferably comprise:
a safety belt warning system of the vehicle seat; and/or
a controller of the airbag assigned to the vehicle seat; and/or
an airbag warning system assigned to the vehicle seat; and/or
a ventilation and/or climate control system assigned to the vehicle seat; and/or
a seat heater assigned to the vehicle seat; and/or
an entertainment system assigned to the vehicle seat; and/or
a child safety lock assigned to the vehicle seat of the corresponding vehicle door and/or the corresponding vehicle window; and/or
any further system assigned to the vehicle seat.

The foregoing disclosure has been set forth merely to illustrate the present subject matter and is not intended to be limiting. Since modifications of the disclosed examples incorporating the spirit and substance of the present subject matter may occur to persons skilled in the art, the present subject matter should be construed to include everything within the scope of the appended claims and equivalents thereof

What is claimed is:

1. A device for exact seat occupancy identification in a vehicle, comprising:
an ultra-wideband (UWB) radar comprising a transmitter and at least two receivers, wherein
the transmitter is configured to emit a plurality of preamble symbols in a direction of a vehicle seat of the vehicle, and
the at least two receivers are configured to receive the preamble symbols reflected by the vehicle seat; and
a computer configured to:
generate Channel Impulse Responses (CIRs) from the received, reflected preamble symbols,
process the generated CIRs using a machine learning algorithm,
carry out an angle-of-arrival calculation based on the reflected preamble symbols; and
determine an occupancy of the vehicle seat from the processed generated CIRs and the performed angle-of-arrival calculation.

2. The device according to claim 1, wherein the computer is further configured to:
in the processing of the CIRs, perform a classification of a person determined in the determination of the occupancy of the vehicle seat with respect to:
an age or age group of the person; and/or
a health status of the person.

3. The device according to claim 1, further comprising:
an electronic control unit configured to control or regulate one or more vehicle functions based on the determined occupancy of the vehicle seat, wherein
the one or more vehicle functions comprise:
a safety belt warning system of the vehicle seat;
a controller of an airbag assigned to the vehicle seat;
an airbag warning system assigned to the vehicle seat;
a ventilation and/or climate control system assigned to the vehicle seat;
a seat heater assigned to the vehicle seat;
an entertainment system assigned to the vehicle seat;
a child safety lock assigned to the vehicle seat of a corresponding vehicle door and/or a corresponding vehicle window; and/or
any further system assigned to the vehicle seat.

4. A vehicle comprising a device according to claim 1.

5. A method for exact seat occupancy identification in a vehicle, comprising:
transmitting, via a transmitter (TRx) of a UWB radar, a plurality of preamble symbols in a direction of a vehicle seat of the vehicle;
receiving, via at least two receivers (TRx, Rx) of the UWB radar, the preamble symbols reflected by the vehicle seat;
generating, via a computer, Channel Impulse Responses (CIRs) from the reflected preamble symbols;
processing, via the computer, the CIRs by using a machine learning algorithm;
performing, by the computer, an angle-of-arrival calculation based on the reflected preamble symbols; and
determining, via the computer, an occupancy of the vehicle seat from the processed CIRs and the performed angle-of-arrival calculation.

6. The method according to claim 5, wherein
the computer is further configured to:
in the processing of the CIRs, perform a classification of a person determined in the determination of the occupancy of the vehicle seat with respect to:
an age of the person; and/or
a health status of the person.

7. The method according to claim 5, further comprising:
controlling or regulating, via an electronic control unit, one or more vehicle functions based on the occupancy of the vehicle seat, wherein
the one or more vehicle functions can comprise:
a safety belt warning system of the vehicle seat;
a controller of an airbag assigned to the vehicle seat;
an airbag warning system assigned to the vehicle seat;
a ventilation and/or climate control system assigned to the vehicle seat;
a seat heater assigned to the vehicle seat;
an entertainment system assigned to the vehicle seat;
a child safety lock assigned to the vehicle seat of a corresponding vehicle door and/or a corresponding vehicle window; and/or
any further system assigned to the vehicle seat.

8. A non-transitory computer-readable medium comprising instructions operable, when executed by one or more computing systems, to carry out the method of claim 5.

9. An electronic device, comprising:
a processor; and
a memory in communication with the processor and storing instructions executable by the processor to configure the electronic device to perform the method according to claim 5.
